(19) United States
(12) Patent Application Publication
(10) Pub. No.: US 2024/0249057 A1
(43) Pub. Date: Jul. 25, 2024

(54) ARRANGEMENT METHOD OF SIGNAL LINES AND INTEGRATED CIRCUIT TO WHICH THE ARRANGEMENT METHOD IS APPLIED

(71) Applicant: Samsung Electronics Co., Ltd., Suwon-si (KR)

(72) Inventor: Keiichi Kushida, Suwon-si (KR)

(21) Appl. No.: 18/392,468

(22) Filed: Dec. 21, 2023

(30) Foreign Application Priority Data
Jan. 19, 2023 (KR) 10-2023-0008107

(51) Int. Cl. G06F 30/392; G06F 30/398; G06F 119/06; H01L 27/06; H01L 29/08; H01L 29/94

(52) U.S. Cl. CPC G06F 30/392; G06F 30/398; H01L 27/0629; H01L 29/0865; H01L 29/0882; H01L 29/94; G06F 2119/06

(57) ABSTRACT

Provided is an arrangement method of signal lines applied to an integrated circuit including a plurality of layers including arranging a first signal line extending in a first direction in a first layer, arranging a second signal line extending in a second direction perpendicular to the first signal line in a second layer adjacent to the first layer, and arranging a metal oxide semiconductor (MOS) capacitor below a region, where the first signal line is arranged, wherein a signal, which has a voltage lower than that of a signal flowing through the second signal line, flows through the first signal line.

### CROSS-REFERENCE TO RELATED APPLICATION

This application is based on and claims priority under 35 U.S.C. § 119 to Korean Patent Application No. 10-2023-0008107, filed on Jan. 19, 2023, in the Korean Intellectual Property Office, the disclosure of which is incorporated by reference herein in its entirety.

### BACKGROUND

The inventive concept relates to an arrangement method of signal lines and an integrated circuit to which the arrangement method of the signal lines is applied.

As the demand for high performance, high speed, and/or multi-functionalization for semiconductor devices increases, the degree of integration of the semiconductor devices is increasing. With the trend of high integration of the semiconductor devices, research is actively being conducted to increase integration while design rules especially for arrangement of the semiconductor devices are satisfied.

The integrated circuits may be designed based on standard cells. Layouts of the integrated circuits may be generated by arranging the standard cells according to data defining the integrated circuits and routing the arranged standard cells.

### SUMMARY

The inventive concept provides an arrangement method of signal lines, in which coupling noise between a high voltage signal and a reference voltage signal may be reduced.

According to an aspect of the inventive concept, there is provided an arrangement method of signal lines applied to an integrated circuit including a plurality of layers.

The arrangement method includes arranging a first signal line extending in a first direction in a first layer, arranging a second signal line extending in a second direction perpendicular to the first signal line in a second layer adjacent to the first layer, and arranging a metal oxide semiconductor (MOS) capacitor below a region, where the first signal line is arranged, wherein a signal, which has a voltage lower than that of a signal flowing through the second signal line, flows through the first signal line.

According to another aspect of the inventive concept, there is provided an integrated circuit.

The integrated circuit includes a first layer in which a reference voltage line extending in a first direction is arranged, a second layer in which a high voltage signal line extending in a second direction perpendicular to the first direction is arranged, and a MOS capacitor arranged below a region in which the reference voltage line crosses the high voltage signal line, wherein the first layer is arranged below the second layer.

According to another aspect of the inventive concept, there is provided an integrated circuit.

The integrated circuit includes a first layer in which a reference voltage line extending in a first direction is arranged, a second layer in which a high voltage signal line extending in a second direction perpendicular to the first direction is arranged, and a MOS capacitor arranged below the reference voltage line, wherein the second layer is arranged below the first layer.

### BRIEF DESCRIPTION OF THE DRAWINGS

Embodiments will be more clearly understood from the following detailed description taken in conjunction with the accompanying drawings in which:

FIG. 1 is a flowchart of a design and a manufacturing method of a semiconductor device, according to an example embodiment;

FIG. 2 is a plan view of a semiconductor device according to an example embodiment;

FIGS. 3A and 3B are respectively a block diagram and a plan view to describe an arrangement method of signal lines, according to a comparison example;

FIG. 4A is a block diagram to describe an arrangement method of signal lines, according to an example embodiment;

FIGS. 4B to 4D are respectively a plan view, a perspective view, and a cross-sectional view of an integrated circuit, to which an arrangement method of signal lines is applied, according to example embodiments;

FIGS. 5A and 5B are respectively a plan view and a perspective view of an integrated circuit, to which an arrangement method of signal lines is applied, according to example embodiments;

FIGS. 6A and 6B are respectively a plan view and a perspective view of an integrated circuit, to which an arrangement method of signal lines is applied, according to example embodiments;

FIGS. 7A and 7B are respectively a plan view and a perspective view of an integrated circuit, to which an arrangement method of signal lines is applied, according to example embodiments;

FIG. 8 is a flowchart to describe an arrangement method of signal lines, according to an example embodiment;

FIG. 9 is a diagram of a system-on-chip according to an example embodiment;

FIG. 10 is a diagram of a mobile device according to an example embodiment; and

FIG. 11 is a diagram of a computing system according to an example embodiment.

### DETAILED DESCRIPTION

Hereinafter, desirable embodiments of the inventive concept are described as the following with reference to the accompanying drawings. Like numbers/labels refer to like elements throughout the specification and drawings.

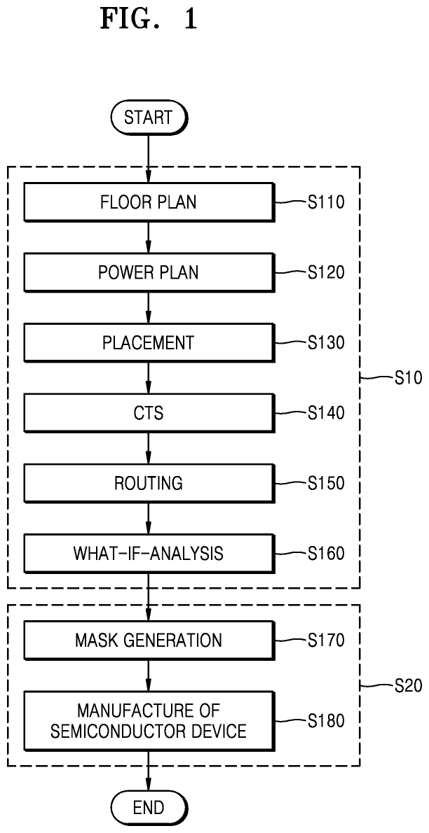

FIG. 1 is a flowchart of a design and a manufacturing method of a semiconductor device, according to an example embodiment. Hereinafter, the terms “semiconductor device” and “semiconductor memory device” may be written interchangeably.

Referring to FIG. 1, the design and the manufacturing method of a semiconductor memory device may respectively include design operation S10 of the semiconductor memory device and manufacturing process operation S20 of the semiconductor memory device. Design operation S10 of the semiconductor memory device may include an operation of designing a layout of a circuit, and may be performed by using a tool for designing a circuit. The tool may include a program including a plurality of commands to be executed by a processor. Accordingly, the design operation S10 of the semiconductor memory device may include a computer-implemented operation for designing a circuit. The manufacturing process operation S20 of the semiconductor memory device may include an operation of manufacturing the semiconductor memory device based on a designed layout, and may be performed in a semiconductor process module.

The design operation S10 of the semiconductor memory device may include a floor plan operation S110, a power plan operation S120, a placement operation S130, a clock tree synthesis (CTS) operation S140, a routing operation S150, and a what-if-analysis operation S160.

The floor plan operation S110 may include an operation of physically designing a semiconductor memory circuit by cutting and moving a logically designed schematic circuit. In the floor plan operation S110, a memory or a functional block may be arranged. In the floor plan operation S110, spaces for the functional blocks may be allocated by, for example, identifying the functional blocks to be arranged adjacent to each other, and considering available spaces, required performance, etc. For example, the floor plan operation S110 may include an operation of generating a site-row and an operation of forming a metal routing track on the generated site-row. The site-row may be a tool for arranging standard cells stored in a cell library according to specified design rules. The metal routing track may include a virtual line, on which wirings are formed in a subsequent process.

The power plan operation S120 may include an operation of arranging patterns of wirings connecting local power sources, for example, a driving voltage or ground, to the arranged functional blocks. For example, patterns of the wirings connecting a power source or ground to the functional blocks may be generated so that power is evenly supplied to the entire chip in a net form. The patterns may include power rails, and in the power plan operation S120, the patterns may be generated in a net form by using various rules. According to an embodiment, power lines may be primarily arranged in the power plan operation S120. In the power plan operation S120, a power line may be arranged along a track region, which is a routable region. According to an embodiment, the power lines may be arranged on the same track region in the power plan operation S120.

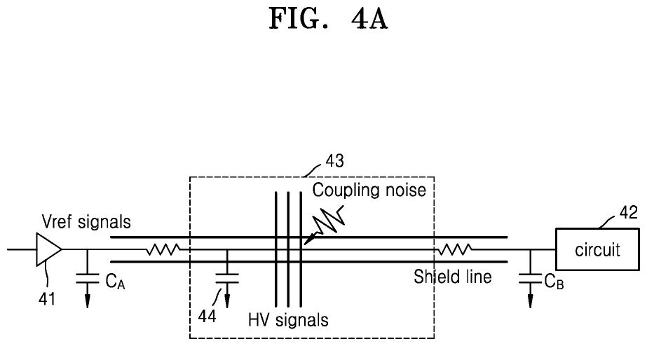

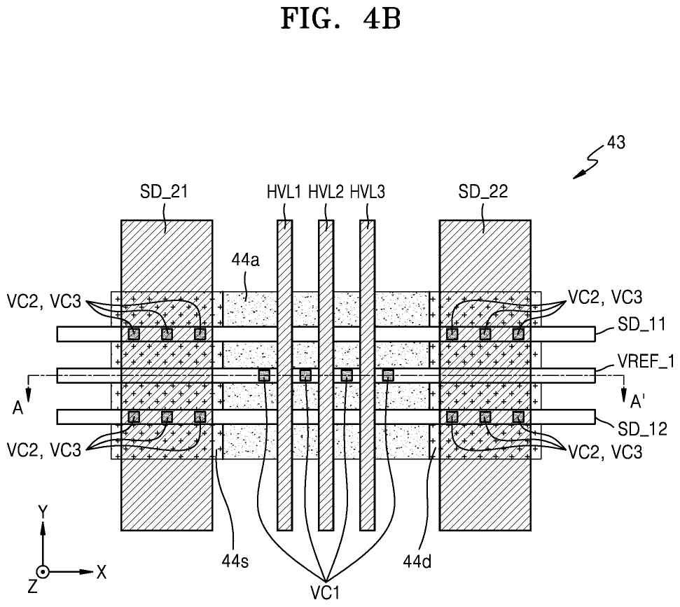

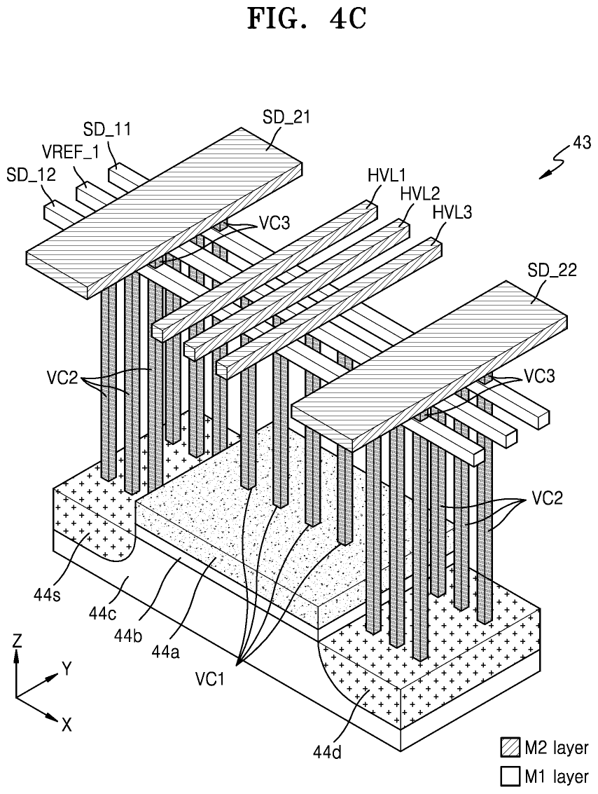

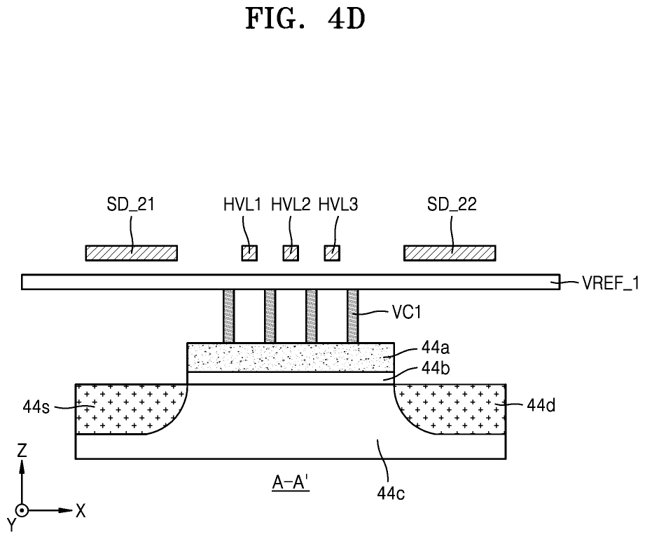

The placement operation S130 may include an operation of arranging patterns of elements constituting the functional block, and may include an operation of arranging standard cells. In particular, in some embodiments, each of the standard cells may include semiconductor devices and first wiring lines connected thereto. The first wiring lines may include a power transmission line connecting the power or ground in the semiconductor device, and a signal transmission line transmitting a control signal, an input signal, or an output signal in the semiconductor device. Empty regions may occur between the standard cells arranged in the placement operation S130, and the empty regions may be filled by filler cells. Unlike the standard cells including operational semiconductor devices and unit circuits implemented with semiconductor devices, the filler cells may include dummy regions. In the placement operation S130, the types or sizes of patterns for constituting transistors and wirings to be actually formed on a semiconductor substrate may be defined. For example, to form an inverter circuit on an actual semiconductor substrate, layout patterns for PMOS, NMOS, N-WELL, gate electrodes, and wirings to be arranged thereon may be appropriately arranged. According to an embodiment, the arrangement of signal lines and the arrangement of a MOS capacitor may be performed in the placement operation S130. This is described below by using FIG. 4A and other drawings thereafter.

The CTS operation S140 may include an operation of generating patterns of signal lines of a center clock related to a response time for determining the performance of the semiconductor memory device.

The routing operation S150 may include an operation of generating an upper wiring structure or a routing structure including second wiring lines connecting the arranged standard cells to each other. The second wiring lines may be electrically connected to the first wiring lines in the standard cells, and may electrically connect the standard cells to each other, or may be connected to a power source or a ground. The second wiring lines may be physically formed on the first wiring lines. According to an embodiment, the routing operation S150 may include an initial routing operation or a final routing operation. The initial routing operation may mean an operation of first generating a routing structure including signal lines, to which a clock signal or the like is applied. The final routing operation may mean a routing operation finally performed after the addition of standard cells is completed.

The what-if-analysis operation S160 may include an operation of verifying and correcting the generated layout. Items of the verifying operation may include a design rule check (DRC) verifying whether the layout complies with the design rule, an electrical rule check (ERC) verifying whether components in the semiconductor memory device are properly electrically connected without disconnections, a layout versus schematic (LVS) check verifying whether the layout matches a gate-level netlist, etc.

The manufacturing process operation S20 of the semiconductor memory device may include a mask generation operation S170 and a manufacturing operation S180 of the semiconductor memory device.

The mask generation operation S170 may include an operation of generating mask data to form various patterns on a plurality of layers by performing optical proximity correction (OPC) on the layout data generated in the design operation S10 of the semiconductor memory device, and an operation of manufacturing a mask by using the mask data. The OPC may include correction of a distortion phenomenon that occurs in a photo-lithography process. The mask may be manufactured by a method of describing layout patterns by using a chromium thin film doped on a glass or quartz substrate.

In the manufacturing operation S180 of the semiconductor memory device, various types of exposure and etching processes may be repeatedly performed. By using these processes, patterns constructed during the layout design may be sequentially formed on the silicon substrate.

Various semiconductor processes may be performed on a semiconductor substrate, such as a wafer by using a plurality of masks, and the semiconductor memory device, in which an integrated circuit is implemented, may be formed. The semiconductor process may include a deposition process, an etching process, an ionization process, a cleaning process, etc. In addition, the semiconductor process may also include a packaging process of mounting the semiconductor memory device on a printed circuit board (PCB) and sealing the semiconductor memory device by using a sealing material, and may also include a test process on the semiconductor memory device or a package thereof.

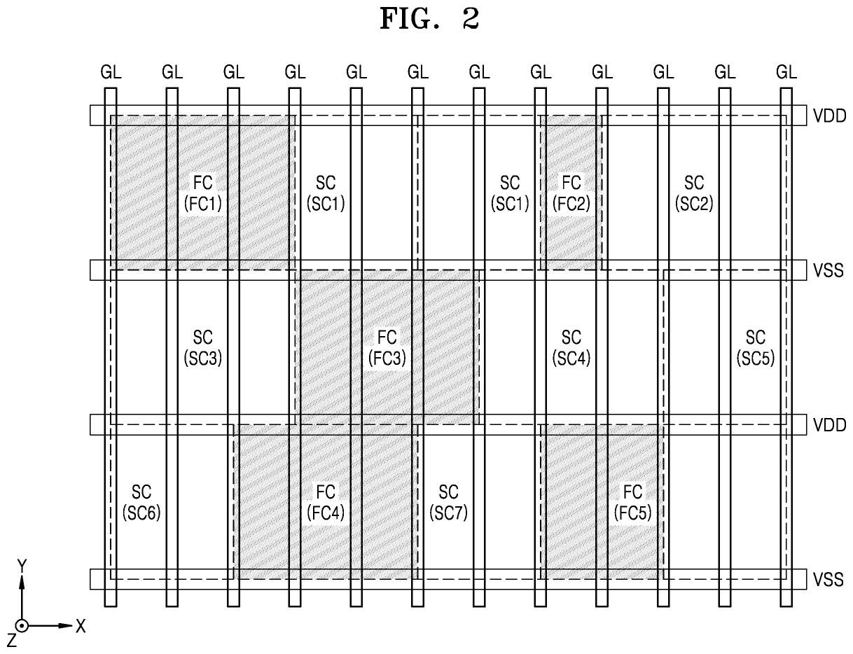

FIG. 2 is a plan view of a semiconductor device according to an example embodiment.

Referring to FIG. 2, the semiconductor device may include standard cell regions SC and filler cell regions FC. In the standard cell regions SC, first through seventh standard cells SC1 through SC7 may be arranged to implement circuits, and in the filler cell regions FC, first through fifth filler cells FC1 through FC5 may be arranged to form a dummy region. The types and numbers of the first through seventh standard cells SC1 through SC7 and the first through fifth filler cells FC1 through FC5 illustrated in FIG. 2 may be examples, and in some embodiments, may be variously changed.

According to an embodiment, the semiconductor device may include a plurality of first standard cells SC1, which are the same as each other. The plurality of first standard cells SC1 may include standard cells designed to perform the same function and include the same layout.

The semiconductor device may include first and second power transmission lines VDD and VSS, and gate lines GL. The first and second power transmission lines VDD and VSS may extend lengthwise in a first direction, for example, the x direction. The first and second power transmission lines VDD and VSS may be arranged to be spaced apart from each other in a second direction, for example, the y direction, crossing the first direction. For example, the first and second power transmission lines VDD and VSS may extend along boundaries between the standard cell regions SC and the filler cell regions FC. According to some embodiments, at least one of the first and second power transmission lines VDD and VSS may also be arranged to cross at least one of the standard cell regions SC and the filler cell regions FC.

The gate lines GL may extend lengthwise in the second direction, and may be arranged to be spaced apart from each other in the first direction. The gate lines GL may include gate electrodes and dummy gate electrodes providing a semiconductor device. For example, the gate lines GL arranged on the boundaries between the standard cell regions SC and the filler cell regions FC may be the dummy gate electrodes.

The gate lines GL and the first and second power transmission lines VDD and VSS illustrated in FIG. 2 may include examples of signal lines, which are arranged in the standard cell regions SC, but the embodiment is not limited thereto.

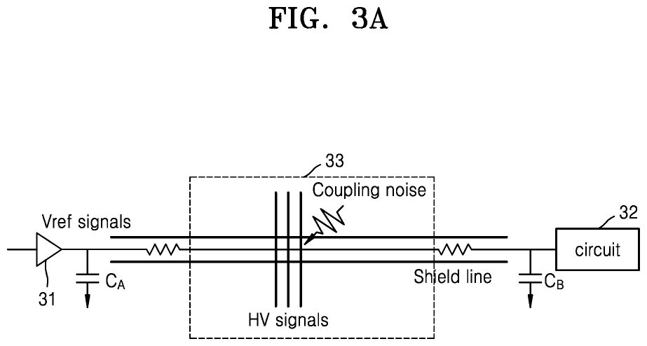

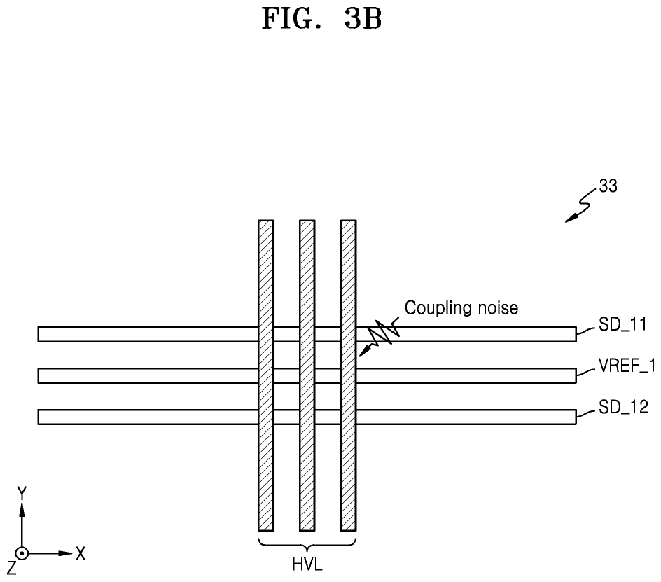

FIGS. 3A and 3B are respectively a diagram and a plan view to describe an arrangement method of signal lines, according to a comparison example.

FIG. 3A is a diagram to describe an arrangement method of signal lines, according to a comparison example. Referring to FIG. 3A, a comparator 31 outputting reference voltage signals Vref signals and a circuit 32 receiving the reference voltage signals Vref signals are illustrated. The reference voltage signals Vref signals output by the comparator 31 may be transferred via a reference voltage line. Shield lines may be arranged on both sides of the reference voltage line, through which the reference voltage signals Vref signals flow.

Referring to FIG. 3A, a high voltage signal line, through which high voltage signals HV signals flow, may be arranged in a direction perpendicular to the reference voltage line. According to an embodiment, the high voltage signal line may be perpendicular to the reference voltage line. Capacitors C_{A} and C_{B} illustrated in FIG. 3A may be parasitic capacitors generated by the reference voltage line in regions where the shield lines are not arranged on both sides of the reference voltage line.

FIG. 3B is a plan view of a layout of a region 33 where the high voltage signal line and the reference voltage line in FIG. 3A intersect with each other. According to an embodiment, a reference voltage line VREF_1, through which the reference voltage signal Vref signals flows, and first shield lines SD_11 and SD_12, which are arranged on both sides of the reference voltage line VREF_1, are illustrated. The first shield lines SD_11 and SD_12 may extend in the same direction as the reference voltage line VREF_1. Coupling noise generated by other voltage lines (not illustrated) on the sides of the reference voltage line VREF_1 may be prevented by the arrangement of the first shield lines SD_11 and SD_12. However, coupling noise generated by a high voltage signal line HVL perpendicular to the reference voltage line VREF_1 may still exist.

FIG. 4A is a diagram to describe an arrangement method of signal lines, according to an example embodiment. In descriptions with respect to FIG. 4A, duplicate descriptions given with reference to FIG. 3A are omitted.

Referring to FIG. 4A, a comparator 41 outputting the reference voltage signals Vref signals and a circuit 42 receiving the reference voltage signals Vref signals are illustrated. The reference voltage signals Vref signals may be applied along a reference voltage line. A high voltage signal line, through which high voltage signals HV signals flow, may be arranged in a direction perpendicular to the reference voltage line. Referring to FIG. 4A, an MOS capacitor 44 may be connected to the reference voltage line. According to an embodiment, the connection of the MOS capacitor 44 thereto may reduce the coupling noise from occurring. Descriptions of a connection relationship between the signal lines and the MOS capacitor 44 are given in more detail with reference to the drawings below.

According to an embodiment, the comparator 41 and the circuit 42 in FIG. 4A may be included in a semiconductor device. According to an embodiment, the semiconductor device may include NAND flash memory. According to an embodiment, the reference voltage signals Vref signals output by the comparator 41 may include a state signal, which is required to maintain a small swing value. According to an embodiment, the high voltage signals HV signals perpendicular to the reference voltage signals Vref signals may include signals, which swing from a ground level to a high voltage HV level. According to an embodiment, the high voltage signals HV signals may include signals having voltages equal to or greater than about 30 V. According to an embodiment, the high voltage signals HV signals may include signals having higher voltages than the reference voltage signals Vref signals. In the inventive concept, a line, through which the reference voltage signals Vref signals flow, is referred to as a reference voltage line, and a line, through which the high voltage signals HV signals flow, is referred to as a high voltage signal line.

FIGS. 4B through 4D are respectively a plan view, a perspective view, and a cross-sectional view of an integrated circuit, to which an arrangement method of signal lines is applied, according to embodiments.

Referring to FIG. 4B, a layout plan view representing a portion corresponding to a layout region 43, where the high voltage signal line intersects with the reference voltage line in FIG. 4A, is illustrated. Referring to FIG. 4C, a layout perspective view representing a portion corresponding to the layout region 43, where the high voltage signal line intersects with the reference voltage line in FIG. 4A, is illustrated. Referring to FIG. 4D, illustrated is a cross-sectional view of the layout plan view taken along line A-A′ in FIG. 4B. According to an embodiment, FIGS. 4B through 4D may be a plan view, a perspective view, and a cross-sectional view of an integrated circuit corresponding to the layout region 43, which is illustrated. Plan views, perspective views, and cross-sectional views illustrated in the following drawings may be respectively plan views, perspective views, and cross-sectional views of an integrated circuit corresponding to the layout region 43 illustrated in FIG. 4A. Hereinafter, the layout regions and the reference numbers of the integrated circuit may be written down in the same manner.

Referring to FIGS. 4B through 4D, the integrated circuit corresponding to the layout region 43 may include a plurality of layers. The reference voltage line VREF_1 may be arranged in a first layer M1 layer. High voltage signal lines HVL1, HVL2, and HVL3 may be arranged in a second layer M2 layer. According to an embodiment, the first layer M1 layer, in which the reference voltage line VREF_1 is arranged, may be different from the second layer M2 layer, in which the high voltage signal lines HVL1, HVL2, and HVL3 are arranged. The first layer M1 layer may be arranged below the second layer M2 layer. In example embodiments, a lower surface of the first layer M1 layer may contact an upper surface of the second layer M2 layer. The reference voltage line VREF_1 and each of the high voltage signal lines HVL1, HVL2, and HVL3 may extend in directions perpendicular to each other. According to an embodiment, the reference voltage line VREF_1 may extend lengthwise in the first direction, and the high voltage signal lines HVL1, HVL2, and HVL3 may extend lengthwise in the second direction. According to an embodiment, the first direction may be the X-axis direction, and the second direction may be the Y-axis direction.

Referring to FIGS. 4B through 4D, the first shield lines SD_11 and SD_12 may be respectively arranged on both sides of the reference voltage line VREF_1. Second shield lines SD_21 and SD_22 may respectively be arranged on both sides of the high voltage signal lines HVL1, HVL2, and HVL3.

According to an embodiment, the reference voltage line VREF_1 and the first shield lines SD_11 and SD_12 may extend in the same direction, or the first direction. The high voltage signal lines HVL1, HVL2, and HVL3 and the second shield lines SD_21 and SD_22 may extend in the same direction, or the second direction. According to an embodiment, the reference voltage line VREF_1 may be arranged apart from the first shield lines SD_11 and SD_12. The high voltage signal lines HVL1, HVL2, and HVL3 may be arranged apart from the second shield lines SD_21 and SD_22.

In some embodiments, the number of reference voltage lines VREF_1 is illustrated as one, and the number of high voltage signal lines HVL1, HVL2, and HVL3 is illustrated as three, but the embodiments are not limited thereto. According to other embodiments, the number of reference voltage lines VREF_1 may be provided in plural in a corresponding layer, and the number of high voltage signal lines HVL1, HVL2, and HVL3 may also be provided as more or less than three in a corresponding layer.

Referring to FIGS. 4B and 4C, the MOS capacitor 44 may be arranged below a region where the reference voltage line VREF_1 crosses the high voltage signal lines HVL1, HVL2, and HVL3. According to an embodiment, a gate region 44a of the MOS capacitor 44 may be arranged under the region where the reference voltage line VREF_1 crosses the high voltage signal lines HVL1, HVL2, and HVL3.

Referring to FIG. 4C, the MOS capacitor 44 may include the gate region 44a, a gate oxide region 44b arranged under the gate region 44a, an active region 44c, and source and drain regions 44s and 44d. The structure of the MOS capacitor 44 may be applied in the same manner to other drawings below.

Referring to FIG. 4C, the gate region 44a of the MOS capacitor 44 may be electrically connected to the reference voltage line VREF_1 via a first vertical contact VC1. The first vertical contact VC1 may be provided in plural. Although in FIG. 4B the number of first vertical contacts VC1 is illustrated as four, the embodiment is not limited thereto.

Referring to FIGS. 4B and 4C, the first shield lines SD_11 and SD_12 included in the first layer M1 layer may be electrically connected to the second shield lines SD_21 and SD_22 included in the second layer M2 layer via a third vertical contact VC3. The first shield lines SD_11 and SD_12 included in the first layer M1 layer may be electrically connected to the source and drain regions 44s and 44d of the MOS capacitor 44 via a second vertical contact VC2. Each of the second vertical contact VC2 and the third vertical contact VC3 may be provided in plural. The numbers of second vertical contacts VC2 and third vertical contact VC3 may not be limited to as illustrated in FIG. 4B.

According to an embodiment, each of the first vertical contact VC1, the second vertical contact VC2, and the third vertical contact VC3 may electrically connect different lines arranged in different layers or components of the MOS capacitors 44, to each other.

FIG. 4D is a cross-sectional view of the layout of FIG. 4B taken along line A-A′.

Referring to FIG. 4D, the reference voltage line VREF_1 arranged in a first layer, the high voltage signal lines HVL1, HVL2, and HVL3 arranged in a second layer, and second shield lines SD_21 and SD_22 arranged on both sides of the high voltage signal lines HVL1, HVL2, and HVL3 are illustrated. In addition, the gate region 44a of the MOS capacitor 44 may be arranged below the reference voltage line VREF_1. The reference voltage line VREF_1 may be electrically connected to the gate region 44a of the MOS capacitor 44 with the shortest distance via the first vertical contact VC1.

Referring to FIG. 4D, the second shield lines SD_21 and SD_22 may be arranged above the source and drain regions 44s and 44d of the MOS capacitor 44.

According to embodiments of FIGS. 4A through 4D, the MOS capacitor 44 may be arranged below crossing points where the reference voltage line VREF_1 crosses the high voltage signal lines HVL1, HVL2, and HVL3, and the gate region 44a of the MOS capacitor 44 may be electrically connected to the reference voltage line VREF_1. The first shield lines SD_11 and SD_12 blocking the reference voltage line VREF_1 and the second shield lines SD_21 and SD_22 blocking the high voltage signal lines HVL1, HVL2, and HVL3 may be electrically connected to the source and drain regions 44s and 44d of the MOS capacitor 44. According to an embodiment, by connecting the reference voltage line VREF_1 to the gate region 44a of the MOS capacitor 44, a parasitic capacitance between the reference voltage signal flowing through the reference voltage line VREF_1, and the first shield lines SD_11 and SD_12, and the second shield lines SD_21 and SD_22 may be sufficiently increased compared with a parasitic capacitance between an upper layer of the reference voltage line VREF_1 and the reference voltage signal. Accordingly, the parasitic capacitance may reduce the effect of a high voltage signal in a vertical direction, and reduce the coupling noise.

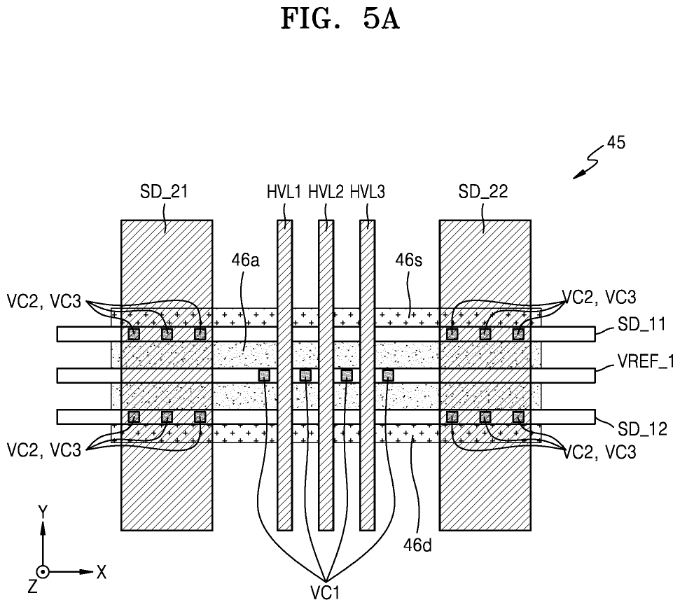

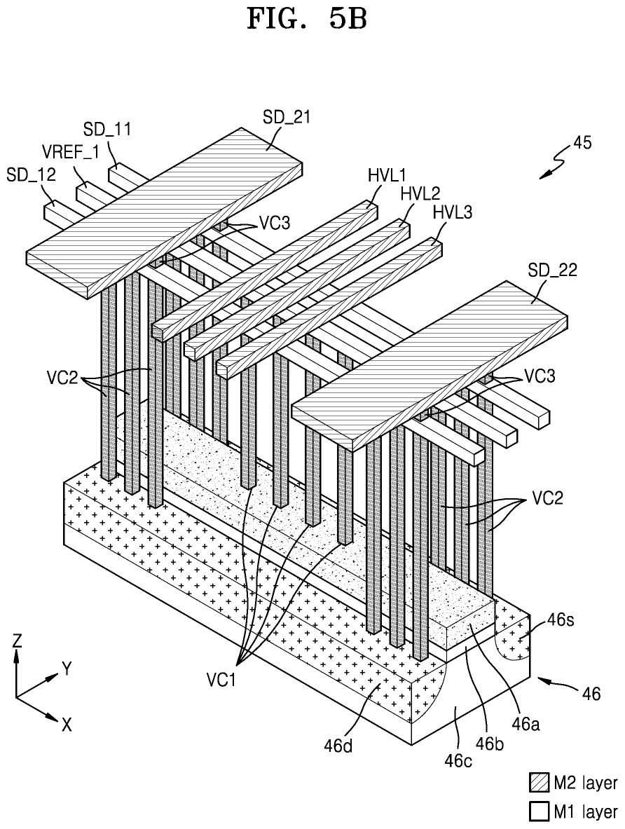

FIGS. 5A and 5B are respectively a plan view and a perspective view of an integrated circuit 45, to which an arrangement method of signal lines is applied, according to example embodiments.

In descriptions with respect to FIGS. 5A and 5B, duplicate descriptions given with respect to FIGS. 4A through 4D are omitted. In FIGS. 5A and 5B, components of the same reference numerals as those in FIGS. 4A through 4D mean the same components.

Referring to FIGS. 5A and 5B, the arrangement of the high voltage signal lines HVL1, HVL2, and HVL3 and the arrangement of the reference voltage line VREF_1 may be the same as illustrated in FIG. 4A. In addition, the arrangements of the first shield lines SD_11 and SD_12, and the second shield lines SD_21 and SD_22 may also be the same as illustrated in FIG. 4A.

Referring to FIGS. 5A and 5B, an arrangement direction of a MOS capacitor 46 included in an integrated circuit 45 may be different from the MOS capacitor 44 illustrated in FIG. 4A. In FIGS. 5A and 5B, the MOS capacitor 46 may include the gate region 46a, a gate oxide region 46b arranged under the gate region 46a, an active region 46c, and source and drain regions 46s and 46d.

According to the embodiments of FIGS. 5A and 5B, in the MOS capacitor 46, source and drain regions 46s and 46d may be formed such that the MOS capacitor 46 extends in the second direction (Y-axis direction) based on a gate region 46a of the MOS capacitor 46. According to the embodiments of FIGS. 4A through 4D, in the MOS capacitor 44, the source and drain regions 44s and 44d may be formed such that the MOS capacitor 44 extends in the first direction (X-axis direction) based on the gate region 44a of the MOS capacitor 44.

Referring to FIG. 5B, the gate region 46a of the MOS capacitor 46 may be electrically connected to the reference voltage line VREF_1 via the first vertical contact VC1. Referring to FIG. 5B, the source and drain regions 46s and 46d of the MOS capacitor 46 may be electrically connected to the first shield lines SD_11 and SD_12 via the second vertical contact VC2, and to the second shield lines SD_21 and SD_22 via the second vertical contact VC2 and the third vertical contact VC3.

Referring to the embodiments of FIGS. 4A through 5B, embodiments of integrated circuits, in which the high voltage signal lines HVL1, HVL2, and HVL3 are arranged in an upper layer of the reference voltage line VREF_1, are disclosed. According to an embodiment, the gate regions 44a and 46a of the MOS capacitors 44 and 46 may be respectively arranged directly below locations where the reference voltage line VREF_1 perpendicularly crosses the high voltage signal lines HVL1, HVL2, and HVL3. The gate regions 44a and 46a of the MOS capacitors 44 and 46 may both be electrically connected to the reference voltage line VREF_1 with the shortest distance via the first vertical contact VC1. The source and drain regions 44s and 44d of the MOS capacitors 44 and the source and drain regions 46s and 46d of the MOS capacitors may be electrically connected to the first shield lines SD_11 and SD_12 with the shortest distance via the second vertical contact VC2, and may be electrically connected to the second shield lines SD_21 and SD_22 with the shortest distance via the second vertical contact VC2 and the third vertical contact VC3. Due to the structure described above, a parasitic capacitance generated by a connected MOS capacitor becomes sufficiently larger than a parasitic capacitance between a high voltage signal in an upper layer and the reference voltage signal due to the reference voltage line VREF_1, and thus, noise generated by a high voltage signal line may be sufficiently reduced.

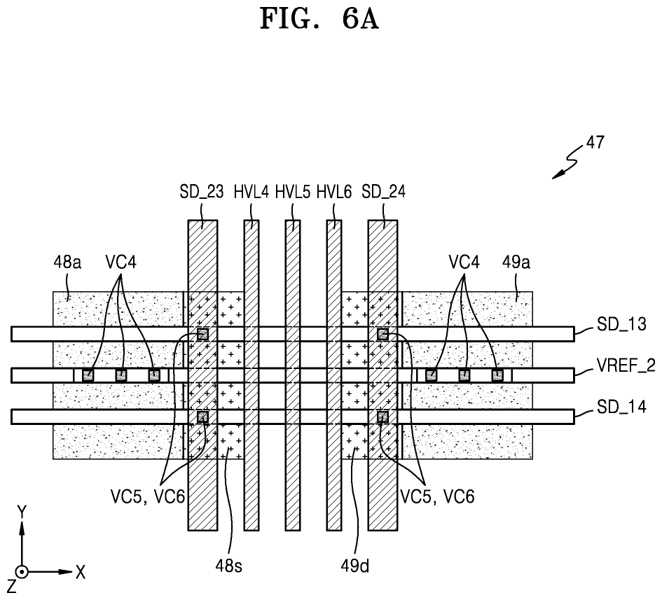

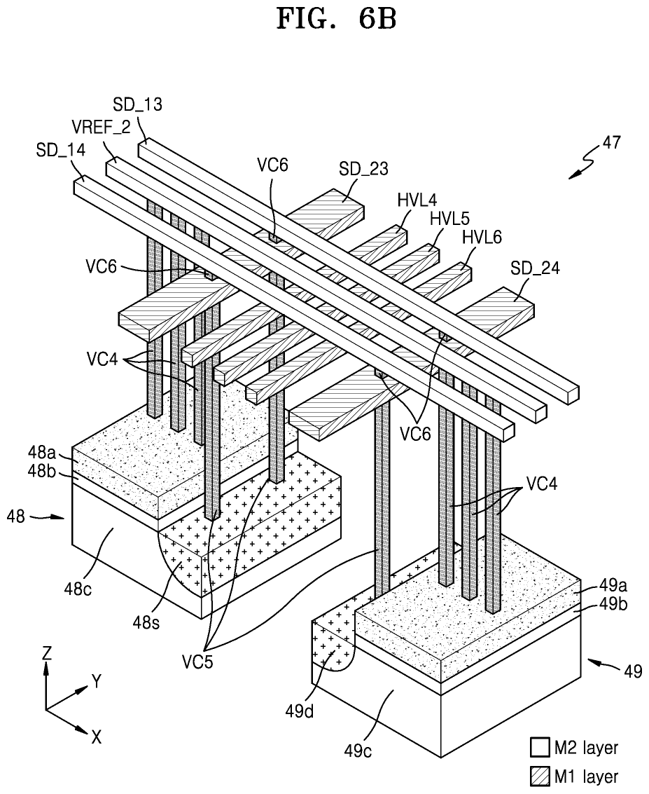

FIGS. 6A and 6B are respectively a plan view and a perspective view of an integrated circuit 47, to which an arrangement method of signal lines is applied, according to example embodiments. In FIGS. 6A and 6B, the MOS capacitor 48 may include the gate region 48a, a gate oxide region 48b arranged under the gate region 48a, an active region 48c, and source region 48s, and the MOS capacitor 49 may include the gate region 49a, a gate oxide region 49b arranged under the gate region 49a, an active region 49c, and drain region 49d.

Referring to FIGS. 6A and 6B, the plan view and the perspective view of the integrated circuit 47 are respectively illustrated, to which a layout is applied, in which high voltage signal lines HVL4, HVL5, and HVL6 are arranged in the first layer M1 layer, and a reference voltage line VREF_2 is arranged in the second layer M2 layer.

Referring to FIGS. 6A and 6B, embodiments are illustrated, in which the high voltage signal lines HVL4, HVL5, and HVL6, and second shield lines SD_23 and SD_24 on both sides of the high voltage signal lines HVL4, HVL5, and HVL6 are arranged in the first layer M1 layer, the reference voltage line VREF_2 and first shield lines SD_13 and SD_14 arranged on both sides of the reference voltage line VREF_2 are arranged in the second layer M2 layer.

Referring to FIGS. 6A and 6B, MOS capacitors 48 and 49 may be arranged below the high voltage signal lines HVL4, HVL5, and HVL6, and the reference voltage line VREF_2. According to an embodiment, gate regions 48a and 49a of the MOS capacitors 48 and 49 may both be connected to the reference voltage line VREF_2. To respectively connect the reference voltage line VREF_2 to the gate regions 48a and 49a of the MOS capacitors 48 and 49, the reference voltage line VREF_2 may be respectively connected to the gate regions 48a and 49a of the MOS capacitors 48 and 49 in regions other than a region where the high voltage signal lines HVL4, HVL5, and HVL6 cross the reference voltage line VREF_2. The reference voltage line VREF_2 may be electrically connected to both of the gate regions 48a and 49a of the MOS capacitors 48 and 49 via first vertical contacts VC4.

The second shield lines SD_23 and SD_24 arranged in the first layer M1 may be electrically connected to the first shield lines SD_13 and SD_14 arranged in the second layer M2 layer via third vertical contacts VC6. The second shield lines SD_23 and SD_24 arranged in the first layer M1 layer may be electrically and respectively connected to source and drain regions 48s and 49d of the MOS capacitor 48 and 49, via second vertical contacts VC5.

According to the embodiment of FIG. 6A, the length of each of the first vertical contacts VC4 may be greater than the lengths of the first vertical contacts VC1 in the embodiments of FIGS. 4C and 5A. According to the embodiment of FIG. 6A, the length of each of the second vertical contacts VC5 may be shorter than the lengths of the second vertical contacts VC2 in the embodiments of FIGS. 4C and 5A.

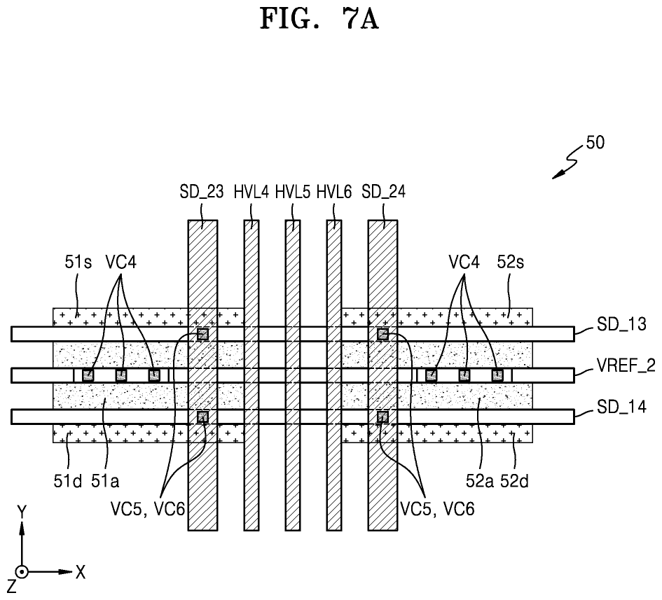

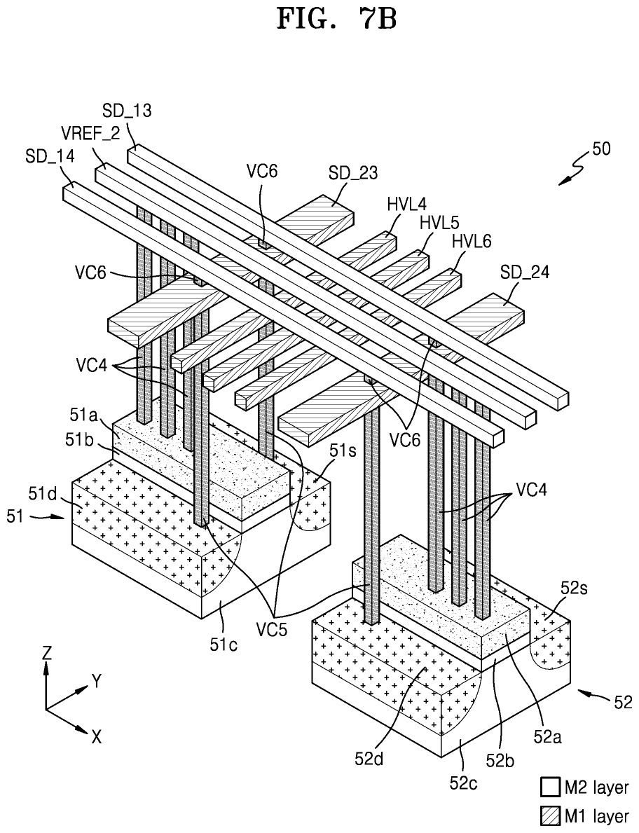

FIGS. 7A and 7B are respectively a plan view and a perspective view of an integrated circuit 50, to which an arrangement method of signal lines is applied, according to embodiments.

In the description of FIGS. 7A and 7B, duplicate descriptions given with reference to FIGS. 6A and 6B are omitted. In FIGS. 7A and 7B, components of the same reference numerals as those in FIGS. 6A and 6B mean the same components.

In FIGS. 7A and 7B, the MOS capacitor 51 may include the gate region 51a, a gate oxide region 51b arranged under the gate region 51a, an active region 51c, and source and drain regions 51s and 51d, and the MOS capacitor 52 may include the gate region 52a, a gate oxide region 52b arranged under the gate region 52a, an active region 52c, and source and drain regions 52s and 52d.

Referring to FIGS. 7A and 7B, the arrangement of the high voltage signal lines HVL4, HVL5, and HVL6 and the arrangement of the reference voltage line VREF_2 may be the same as illustrated in FIG. 6A. In addition, the arrangement of the first shield lines SD_13 and SD_14, and the second shield lines SD_23 and SD_24 may also be the same as illustrated in FIG. 6A.

Referring to FIGS. 7A and 7B, an arrangement direction of MOS capacitors 51 and 52 included in the integrated circuit 50 may be different from that illustrated in FIG. 6A.

According to the embodiments of FIGS. 7A and 7B, in the MOS capacitors 51 and 52, source and drain regions 51s and 51d, and source and drain regions 52s and 52d may be formed such that the MOS capacitors 51 and 52 extend in the second direction (Y-axis direction) based on gate regions 51a and 52a of the MOS capacitors 51 and 52. According to the embodiments of FIGS. 6A through 6D, source and drain regions 48s and 49d may be formed such that MOS capacitors 48 and 49 extend in the first direction (X-axis direction) based on the gate regions 48a and 49a of the MOS capacitors 48 and 49, respectively.

Referring to FIG. 7B, the gate regions 51a and 52a of the MOS capacitors 51 and 52 may be electrically connected to the reference voltage line VREF_2 via the first vertical contacts VC4. Referring to FIG. 7B, the source and drain regions 51s and 51d the MOS capacitor 51 and the source and drain regions 52s and 52d of the MOS capacitor 52 may be electrically connected to the first shield lines SD_13 and SD_14 via the second vertical contacts VC5, and may be electrically connected to the second shield lines SD_23 and SD_24 via the second vertical contacts VC5 and the third vertical contacts VC6.

Referring to the embodiments of FIGS. 6A through 7B, embodiments of integrated circuits, in which the high voltage signal lines HVL4, HVL5, and HVL6 are arranged on a lower layer of the reference voltage line VREF_2, are disclosed. When the high voltage signal lines HVL4, HVL5, and HVL6 are arranged on the lower layer of the reference voltage line VREF_2 and gate regions of a MOS capacitor are arranged below a region, where the reference voltage line VREF_2 crosses the high voltage signal lines HVL4, HVL5, and HVL6, the reference voltage line VREF_2 may not be vertically connected to the gate regions of the MOS capacitor due to the high voltage signal lines HVL4, HVL5, and HVL6 disposed therebelow. In the side portions, which is not the region where the reference voltage line VREF_2 crosses the high voltage signal lines HVL4, HVL5, and HVL6, the first shield lines SD_13 and SD_14 and the second shield lines SD_23 and SD_24 may be electrically connected to the source and drain regions, that is, 48s, 49d, 51s, 51d, 52s, and 52d, of the MOS capacitors 48, 49, 51, and 52. In addition, the gate regions 48a, 49a, 51a and 51a of the MOS capacitors 48, 49, 51, and 52 may be electrically connected to the reference voltage line VREF_2 via the first vertical contacts VC4. In this manner, because the parasitic capacitance between the reference voltage signal, and the first shield lines SD_13 and SD_14 and the second shield lines SD_23 and SD_24 is sufficiently large, compared with the parasitic capacitance between the reference voltage signal of the reference voltage line VREF_2 in the upper layer and a high voltage signal in the lower layer, the noise effect of the high voltage signal may be reduced.

According to an embodiment, in a layout structure of an integrated circuit, in which a high voltage signal is distributed on an upper layer or a lower layer of a reference voltage signal, a gate region of a MOS capacitor may be arranged directly below the reference voltage signal, the gate region of the MOS capacitor may be connected to the reference voltage signal by the minimum distance via a vertical contact, and source and drain regions may be connected to shield lines of the MOS capacitor by the minimum distance via a vertical contact.

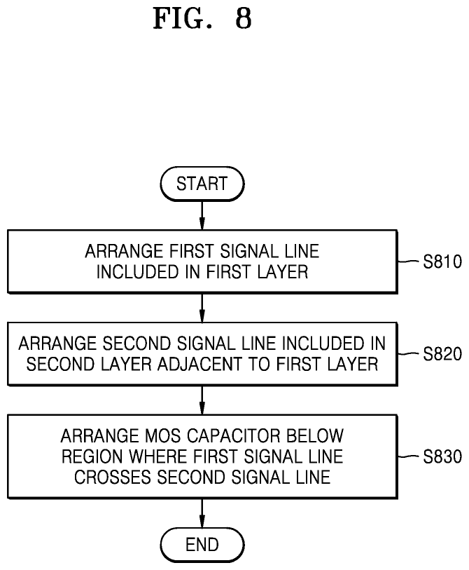

FIG. 8 is a flowchart to describe an arrangement method of signal lines, according to an example embodiment.

Referring to FIG. 8, in operation S810, a first signal line included in the first layer may be arranged. In this case, first shield lines may be arranged on both sides of the first signal line.

In operation S820, a second signal line included in the second layer may be arranged. The second layer may include a layer adjacent to the first layer. Second shield lines may be arranged on both sides of the second signal line.

In operation S830, a MOS capacitor may be arranged below a region, where the first signal line crosses the second signal line. According to an embodiment, gate regions of a MOS capacitor may be arranged below a region, where the first signal line crosses the second signal line.

The gate regions of the MOS capacitor may be electrically connected to the first signal line via a vertical contact. The source and drain regions of the MOS capacitor may be electrically connected to a first shield line and a second shield line via a vertical contact. According to an embodiment, the first signal line may include a reference voltage line and the second signal line may include a high voltage signal line. The first layer may include a lower layer and the second layer may include an upper layer.

According to an embodiment, the flowchart illustrated in FIG. 8 may include an example of a method of arranging signal lines included in the integrated circuit illustrated in FIGS. 4A through 4D, 5A and 5B, 6A and 6B, or 7A and 7B.

Various operations of the aforementioned methods may be performed by any suitable means capable of executing operations, such as software implemented in some forms of a variety of hardware and/or hardware (for example, processors, application-specific integrated circuits (ASICs), or the like).

The software may include an ordered list of executable instructions for implementing logical functions, and may be embedded in any “processor-readable medium” for use only by instruction execution systems, devices, or apparatuses, such as single- or multi-core processors or processor-included systems.

In the inventive concept, the terms “storage medium,” “computer-readable storage medium,” or “non-transitory computer-readable storage medium” may represent one or more devices for storing data, such as read-only memory (ROM), random access memory (RAM), magnetic RAM (MRAM), core memory, magnetic disk storage media, optical storage media, flash memory devices, and/or devices including other real machine-readable media for storing information. The “computer-readable media” may include, as non-limiting examples, portable or fixed storage devices, optical storage devices, or various other media capable of storing, including, or transporting command(s) and/or data.

Furthermore, the example embodiments may be implemented in hardware, software, firmware, middleware, microcode, hardware description languages (HDL), or any combination thereof. When the example embodiments are implemented in software, firmware, middleware, or microcode, program code or code segments for performing necessary operations may be stored in a machine or computer-readable medium such as a computer-readable storage medium. When the embodiments are implemented as software, processor(s) may be programmed to perform necessary operations and may thus be converted into processors(s) or computers(s) for particular purpose.

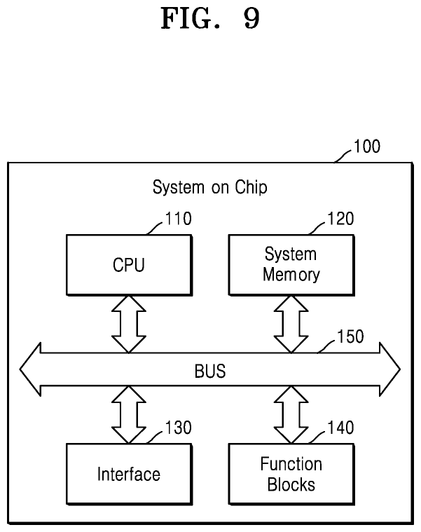

FIG. 9 is a diagram of a system-on-chip 100 according to an example embodiment.

Referring to FIG. 9, the system on chip 100 may include a central processing unit (CPU) 110, a system memory 120, an interface 130, function blocks 140, and a bus 150 connecting these components to each other. The CPU 110 may control an operation of the system on chip 100. The CPU 110 may include a core and L2 cache. For example, the CPU 110 may include a multi-core. Each core of the multi-core may be the same as or different from each other. In addition, each core of the multi-core may be simultaneously activated, or may have different time points of activation. The system memory 120 may store results processed by the function blocks 140 under the control of the CPU 110. For example, content stored in the L2 cache of the CPU 110 may be stored in the system memory 120 as the L2 cache thereof is flushed. The interface 130 may interface with external devices. For example, the interface 130 may interface with a camera, a liquid crystal display (LCD), a speaker, etc.

The function blocks 140 may perform various functions required by the system on chip 100. For example, the function blocks 140 may perform video codec operations, or process three-dimensional (3D) graphics.

As is traditional in the field of the disclosed technology, features and embodiments are described, and illustrated in the drawings, in terms of functional blocks or modules. Those skilled in the art will appreciate that these blocks and modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks and modules being implemented by microprocessors or similar, they may be programmed using software (e.g., microcode) to perform various functions discussed herein and may optionally be driven by firmware and/or software. Alternatively, each block and/or module may be implemented by dedicated hardware, or as a combination of dedicated hardware to perform some functions and a processor (e.g., one or more programmed microprocessors and associated circuitry) to perform other functions. Also, each block and/or module of the embodiments may be physically separated into two or more interacting and discrete blocks and/or modules without departing from the scope of the inventive concepts. Further, the blocks and modules of the embodiments may be physically combined into more complex blocks and modules without departing from the scope of the inventive concepts.

The system on chip 100 according to an embodiment may, in a structure where a high voltage signal is distributed to an upper layer or a lower layer of a reference voltage signal, significantly reduce noise from the high voltage signal with respect to the reference voltage signal, by using a structure, in which the reference voltage signal is connected to a MOS capacitor.

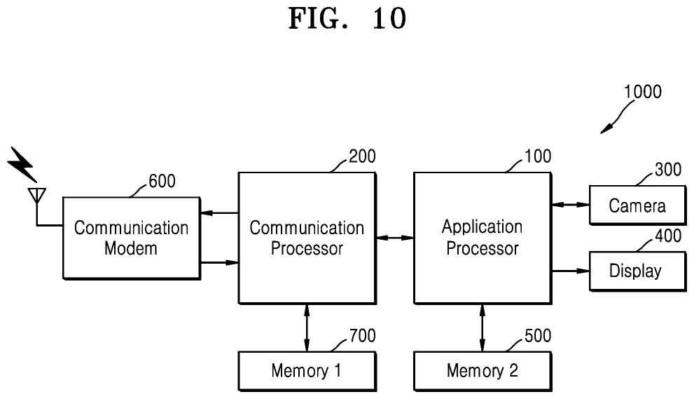

FIG. 10 is a diagram of a mobile device 1000 according to an embodiment. Referring to FIG. 10, the mobile device 1000 may include an application processor 100 which is implemented as the system on chip 100 of FIG. 9, a communication processor 200, a camera 300, a display 400, a communication modem 600, a first memory Memory 1 700, and a second memory Memory 2 500. An application may be executed by the application processor 100 in the mobile device 1000. For example, when an image is captured by using the camera 300, the application processor 100 may store the captured image in the second memory Memory 2 500, and display the captured image on the display 400. The captured image may be transmitted to the outside via the communication modem 600 under the control of the communication processor 200. In this case, to transmit the captured image, the communication processor 200 may temporarily store the captured image in the first memory Memory 1 700. In addition, the communication processor 200 may control communication for a call and control data transmission and reception.

The mobile device 1000 according to an embodiment may, in a structure where a high voltage signal is distributed to an upper layer or a lower layer of a reference voltage signal, significantly reduce noise from the high voltage signal with respect to the reference voltage signal, by using a structure in which the reference voltage signal is connected to a MOS capacitor.

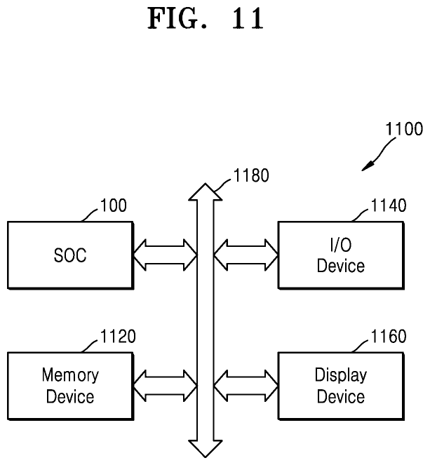

FIG. 11 is a diagram of a computing system 1100 according to an example embodiment. FIG. 11 is a diagram of the computing system 1100 including the system on chip (SoC) 100 of FIG. 9, according to an embodiment. The SoC 100 according to an embodiment may be mounted on the computing system 1100, such as a mobile device, desktop computer and a server.

In addition, the computing system 1100 may further include a memory device 1120, an input/output (I/O) device 1140, and a display device 1160, and these components may be electrically connected to a bus 1180. The computing system 1100 according to an embodiment may, in a structure where a high voltage signal is distributed to an upper layer or a lower layer of a reference voltage signal, significantly reduce noise from the high voltage signal with respect to the reference voltage signal, by using a structure, in which the reference voltage signal is connected to a MOS capacitor.

While the inventive concept has been particularly shown and described with reference to embodiments thereof, it will be understood that various changes in form and details may be made therein without departing from the spirit and scope of the following claims.

What is claimed is:

1. An arrangement method of signal lines applied to an integrated circuit comprising a plurality of layers, the arrangement method comprising:
arranging a first signal line extending in a first direction in a first layer;
arranging a second signal line extending in a second direction perpendicular to the first signal line in a second layer adjacent to the first layer; and
arranging a metal oxide semiconductor (MOS) capacitor below a region where the first signal line is arranged,
wherein a signal, which has a voltage lower than that of a signal flowing through the second signal line, flows through the first signal line.

2. The arrangement method of claim 1, wherein the arranging of the MOS capacitor comprises arranging a gate region of the MOS capacitor below a region where the first signal line crosses the second signal line.

3. The arrangement method of claim 1, wherein the arranging of the MOS capacitor comprises arranging a gate region of the MOS capacitor below a region except where the first signal line crosses the second signal line.

4. The arrangement method of claim 1, wherein the arranging of the first signal line further comprises arranging, in the first layer, a first shield line extending in the first direction on both sides of the first signal line.

5. The arrangement method of claim 4, wherein the arranging of the second signal line further comprises arranging, in the second layer, a second shield line extending in the second direction on both sides of the second signal line.

6. The arrangement method of claim 5, wherein the arranging of the MOS capacitor comprises arranging a source/drain region of the MOS capacitor in a region, where the first shield line crosses the second shield line.

7. The arrangement method of claim 6, wherein the source/drain region of the MOS capacitor is formed to extend in the first direction with respect to the gate region of the MOS capacitor.

8. The arrangement method of claim 6, wherein the source/drain region of the MOS capacitor is formed to extend in the second direction with respect to the gate region of the MOS capacitor.

9. An integrated circuit comprising:
a first layer in which a reference voltage line extending in a first direction is arranged;
a second layer in which a high voltage signal line extending in a second direction perpendicular to the first direction is arranged; and
a metal oxide semiconductor (MOS) capacitor arranged below a region in which the reference voltage line crosses the high voltage signal line,
wherein the first layer is arranged below the second layer.

10. The integrated circuit of claim 9, wherein a gate region of the MOS capacitor is arranged below the region, where the reference voltage line crosses the high voltage signal line.

11. The integrated circuit of claim 10, further comprising a first vertical contact configured to electrically connect the gate region of the MOS capacitor to the reference voltage line.

12. The integrated circuit of claim 9,
wherein the first layer is arranged on both sides of the reference voltage line, and further comprises a first shield line extending in the first direction, and
wherein the second layer is arranged on both sides of the high voltage signal line, and further comprises a second shield line extending in the second direction.

13. The integrated circuit of claim 12, further comprising:
a second vertical contact configured to electrically connect the first shield line to a source/drain region of the MOS capacitor; and
a third vertical contact configured to electrically connect the second shield line to the first shield line.

14. An integrated circuit comprising:
a first layer in which a reference voltage line extending in a first direction is arranged;
a second layer in which a high voltage signal line extending in a second direction perpendicular to the first direction is arranged; and
a metal oxide semiconductor (MOS) capacitor arranged below the reference voltage line,
wherein the second layer is arranged below the first layer.

15. The integrated circuit of claim 14, wherein a gate region of the MOS capacitor is arranged below a region except where the reference voltage line crosses the high voltage signal line.

16. The integrated circuit of claim 15, further comprising:
a first vertical contact configured to electrically connect the gate region of the MOS capacitor to the reference voltage line.

17. The integrated circuit of claim 14,
wherein the first layer is arranged on both sides of the reference voltage line, and further comprises a first shield line extending in the first direction, and
wherein the second layer is arranged on both sides of the high voltage signal line, and further comprises a second shield line extending in the second direction.

18. The integrated circuit of claim 17, further comprising:
a second vertical contact configured to electrically connect the first shield line to a source/drain region of the MOS capacitor; and
a third vertical contact configured to electrically connect the second shield line to the first shield line.

19. The integrated circuit of claim 18, wherein the source/drain region of the MOS capacitor is arranged below a region except where the reference voltage line crosses the high voltage signal line.

20. The integrated circuit of claim 19, wherein the source/drain region of the MOS capacitor is formed to extend in the first direction with respect to a gate region of the MOS capacitor.
